(19) United States
(12) Patent Application Publication
(10) Pub. No.: US 2024/0194957 A1
(43) Pub. Date: Jun. 13, 2024

(54) BATTERY MODULE ASSEMBLY STRUCTURE FOR VEHICLES

(71) Applicants: HYUNDAI MOTOR COMPANY, Seoul (KR); KIA CORPORATION, Seoul (KR)

(72) Inventors: Yu Ri Oh, Hwaseong-si (KR); In Gook Son, Incheon (KR); Seok Eun Yoon, Seoul (KR)

(73) Assignees: HYUNDAI MOTOR COMPANY, Seoul (KR); KIA CORPORATION, Seoul (KR)

(21) Appl. No.: 18/137,214

(22) Filed: Apr. 20, 2023

(30) Foreign Application Priority Data
Dec. 12, 2022 (KR) 10-2022-0172811

(51) Int. Cl. H01M 10/42; B60L 50/64; H01M 10/48; H01M 50/211; H01M 50/284; H01M 50/519

(52) U.S. Cl. CPC H01M 10/425; B60L 50/64; H01M 10/482; H01M 50/211; H01M 50/284; H01M 50/519; H01M 2010/4271

(57) ABSTRACT

A battery module assembly structure includes a battery module formed by overlapping battery cells and a cell management unit (CMU). The CMU is coupled to a side of the battery module to acquire information on the battery cells constituting the battery module.

### CROSS REFERENCE TO RELATED APPLICATION

The present application claims priority to Korean Patent Application No. 10-2022-0172811, filed Dec. 12, 2022, the entire contents of which are incorporated herein for all purposes by this reference.

### BACKGROUND OF THE DISCLOSURE

### Technical Field

The present disclosure relates to a technology for battery modules that are mounted in a vehicle.

### Description of the Related Art

In order to power a motor that generates a driving force for a vehicle, batteries are mounted in an electric vehicle or a hybrid vehicle.

The batteries mounted in a vehicle as described above are mainly provided in the form of a battery pack.

The battery pack includes a battery case and a plurality of battery modules accommodated in the battery case.

In addition, the battery module is composed of a plurality of battery cells, and for each battery cell, the voltage and temperature thereof need to be sensed and managed. For this purpose, a battery pack is provided with a plurality of cell management units (CMUs). The CMUs transmit information on each battery cell to a battery management system (BMS) that comprehensively manages the state of all battery cells inside the battery pack.

The matters described as the related art above are only to enhance understanding of the background of the present disclosure. Therefore, the matters described above should not be taken as acknowledging that they correspond to the prior art already known to those having ordinary skill in the art.

### SUMMARY OF THE DISCLOSURE

Accordingly, the present disclosure has been made keeping in mind the above problems occurring in the related art. The present disclosure is intended to provide a battery module assembly structure for vehicles. The assembly structure improves space utilization inside a battery case, reduces weight and cost of a battery pack, and makes it very easy to replace and repair a cell management unit (CMU) by arranging multiple CMUs mounted in the battery case more efficiently.

In order to achieve the above objectives, according to an embodiment of the present disclosure, a battery module assembly structure for vehicles is provided. The battery module assembly structure includes a battery module formed by overlapping battery cells and a CMU. The CMU is coupled to a side of the battery module to acquire information on the battery cells constituting the battery module.

The CMU may be configured to move linearly with respect to the battery module and be coupled to a corner of the battery module.

The CMU may be configured to be coupled to the battery module by moving downward with respect to the battery module. The CMU may also be configured to be separated from the battery module by moving upward with respect to the battery module. The upward and/or downward movement may be movement in a straight line or linear.

The battery module and the CMU may be provided with respective connectors capable of mutual engagement. Thus, the battery module and the CMU may be electrically connected with each other by linear displacement of the CMU with respect to the battery module.

The battery module may be provided with a printed circuit board (PCB) electrically connected to the battery cells constituting the battery module. The connector of the battery module may be provided on the PCB.

Cell electrodes may be provided on at least on one side of the battery cells constituting the battery module. The cell electrodes may be respectively connected to bus bars provided in a sensing block. The PCB may be mounted on the sensing block so as to be connected to the bus bars.

The CMU may be coupled to an upper corner of the battery module and may be configured to wirelessly transmit information on the individual battery cells constituting the battery module to a battery management system (BMS).

In order to achieve the above objectives, according to an embodiment of the present disclosure, a battery pack for vehicles is provided. The battery pack includes a plurality of battery module assemblies each having a battery module formed by overlapping battery cells. Each battery module also includes a CMU coupled to a side of the battery module to acquire information on the battery cells constituting the battery module. Furthermore, the CMUs are configured to wirelessly transmit the acquired information on each of the battery cells to a BMS. The battery pack further includes a battery case that is provided to accommodate the plurality of battery module assemblies and the BMS. The BMS is provided in the battery case to receive the acquired information on each of the battery cells transmitted from respective CMUs of the plurality of battery module assemblies.

The plurality of battery module assemblies may be disposed in a single layer in the battery case. The CMU of each of the battery module assemblies may be coupled to an upper corner of the corresponding battery module. The CMUs of the battery module assemblies and the BMS may communicate through a space formed between an upper side of the battery modules and an upper cover of the battery case.

The CMUs may be configured to be coupled to the respective battery modules by moving downward with respect to the battery module and may be configured to be separated from the battery module by moving upward with respect to the battery module. The upward and downward movement may be straight line or linear movement.

Each of the battery modules and the CMUs may be provided with respective connectors capable of mutual engagement. Thus, the battery modules and the CMUs may be electrically connected with each other by linear displacement of the CMUs with respect to the battery modules.

The battery modules may each be provided with a printed circuit board (PCB) electrically connected to the battery cells constituting the battery module. The connector of each battery module may be provided on the PCB.

Cell electrodes may be provided on at least one side of the battery cells constituting each of the battery modules. The cell electrodes may be respectively connected to bus bars provided in a sensing block of each battery module and the PCBs may be mounted on the sensing blocks so as to be connected to the bus bars.

As described above, according to the present disclosure, it is possible to improve space utilization inside a battery case, reduce the weight and cost of a battery pack, and make it very easy to replace and repair a cell management unit (CMU) by arranging multiple CMUs mounted in the battery case more efficiently or appropriately.

### BRIEF DESCRIPTION OF THE DRAWINGS

The above and other objectives, features, and other advantages of the present disclosure should be more clearly understood from the following detailed description when taken in conjunction with the accompanying drawings, in which:

FIG. 1 is a view showing an example of a battery pack to which a battery module assembly structure for vehicles according to the present disclosure is applied;

FIG. 2 is a view showing the battery module assembly structure according to the present disclosure;

FIG. 3 is a view showing a sensing block provided in a battery module of FIG. 2;

FIG. 4 is a view showing a battery cell constituting the battery module of FIG. 2; and

FIG. 5 is a view showing communication between a cell management unit (CMU) and a battery management system (BMS) through the space between an upper cover of a battery case and the battery module.

### DETAILED DESCRIPTION

Hereinafter, embodiments disclosed in the present specification are described in detail with reference to the accompanying drawings. The same or similar elements are assigned the same reference numerals throughout the drawings and overlapping descriptions thereof have been omitted.

The expressions “module” and “part” for the elements used in the following description are given in consideration of only the ease of writing the specification, and do not have distinct meanings or roles by themselves.

In describing the embodiments disclosed in this specification, where it has been determined that detailed descriptions of related known technologies may obscure the gist of the embodiments disclosed in this specification, the detailed descriptions thereof have been omitted. In addition, it should be understood that the accompanying drawings are only to help understand the embodiments disclosed in the present specification, and the technical idea disclosed in the present specification is not limited by the accompanying drawings. The disclosure covers all changes, equivalents, and substitutes within the spirit and scope of the present disclosure.

Terms including an ordinal number, such as first, second, and the like, may be used to describe various elements, but the elements are not limited by the terms. These terms are used only for the purpose of distinguishing one element from another.

When an element is referred to as being “connected” to another element, it should be understood that the other element may be directly connected to the other element, but other element (s) may exist in between. On the other hand, when it is said that a certain element is “directly connected” to another element, it should be understood that no other element is present in the middle.

The singular expression includes the plural expression unless the context clearly dictates otherwise.

In this specification, the terms “comprise,” “include,” or “have” and variations thereof are intended to indicate that there is a feature, number, step, action, element, part, or combination thereof described on the specification. It is to be understood that the present disclosure does not exclude the possibility of the presence or the addition of one or more other features, numbers, steps, actions, elements, parts, or combinations thereof. When a component, device, element, or the like of the present disclosure is described as having a purpose or performing an operation, function, or the like, the component, device, or element should be considered herein as being “configured to” meet that purpose of perform that operation or function.

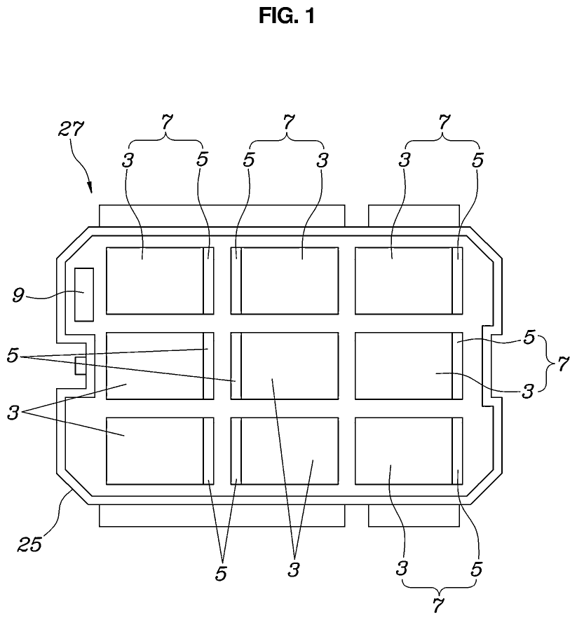

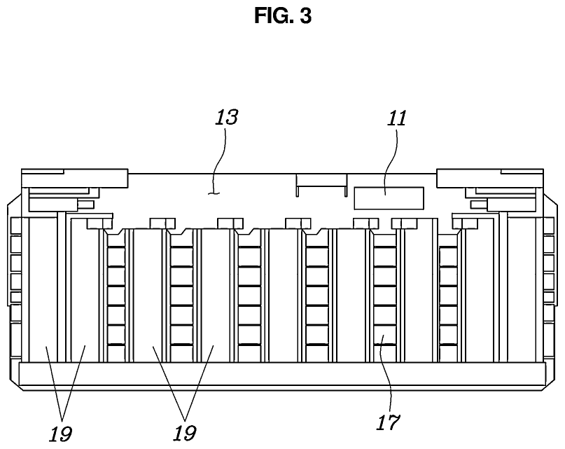

Referring to FIGS. 1-5, a battery module assembly structure for vehicles includes a battery module 3 formed by overlapping battery cells 1 and a cell management unit (CMU) 5. The CMU 5 is coupled to one side of the battery module 3 to acquire information on the battery cells 1 constituting the battery module 3.

In other words, a battery module assembly 7 of the present disclosure is configured by integrally coupling the battery module 3 and the CMU 5 to each other.

Thus, in each battery module assembly 7, the CMU 5 coupled to the corresponding battery module 3 acquires information about voltage and temperature of the battery cells 1 constituting the corresponding battery module 3. Additionally, the CMU 5 transmits the acquired information to a battery management system (BMS) 9.

This battery module assembly structure, when compared to the conventional structure in which a battery module and a CMU are separately provided and connected with wires, eliminates the need for a separate space for mounting a CMU inside a battery case. Furthermore, this eliminates the need for wires connecting the CMU and a battery module, thereby reducing the weight and cost of a battery pack.

The CMU 5 may be configured to move linearly with respect to the battery module 3 and be coupled to one corner of the battery module 3.

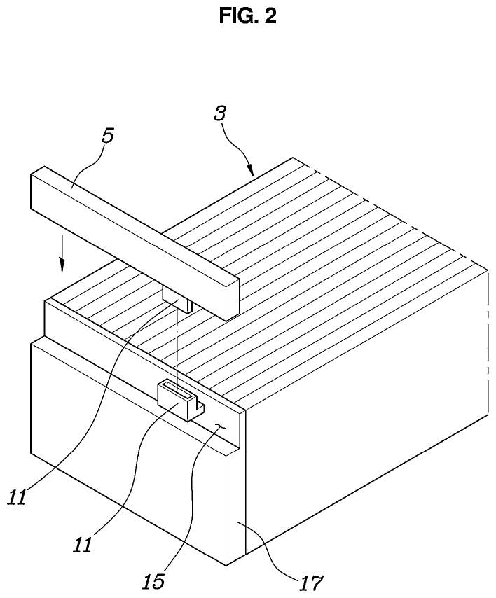

In other words, as shown in FIG. 2, the CMU 5 may be configured to be coupled to the battery module 3 by moving downward in a straight line with respect to the battery module 3. Furthermore, the CMU 5 may be configured to separate from the battery module 3 by moving upward with respect to the battery module 3.

The battery module 3 and the CMU 5 are provided with respective connectors 11 to be able to mutually engage so that the CMU 5 is electrically connected with the battery module 3 by linear displacement. Linear displacement is the movement of the CMU 5 with respect to the battery module 3.

Accordingly, when moving the CMU 5 downward with respect to the battery module 3 so that the connector 11 of the CMU 5 and the connector 11 of the battery module are coupled to each other, the CMU 5 is electrically connected to the battery module 3. Furthermore, the CMU 5 is in a state capable of acquiring information on each battery cell 1 constituting the battery module 3, i.e., information such as voltage and temperature.

The battery module 3 is provided with a printed circuit board (PCB) 13 electrically connected to the battery cells 1 constituting the battery module 3. The connector 11 of the battery module 3 is provided on the PCB 13.

In other words, cell electrodes 15 are provided on at least one side of the battery cells 1 constituting the battery module 3. The cell electrodes 15 are respectively connected to bus bars 19 provided in a sensing block 17 provided in the battery module 3. Additionally, the PCB 13 is mounted on the sensing block 17 so as to be connected to the bus bars 19. Also, the PCB 13 is connected to the CMU 5 through the connector 11 so that the CMU 5 may acquire information such as the voltage of the battery cells 1 constituting the battery module 3.

The CMU 5 is coupled to the upper corner of the battery module 3 and is configured to wirelessly transmit information on individual battery cells 1 constituting the battery module 3 to the BMS 9.

Therefore, when the CMU 5 needs to be replaced or repaired, the entire battery module assembly 7 does not need to be removed from a battery case 27. Instead, only the corresponding CMU 5 may be separated from the battery module 3 by moving the corresponding CMU 5 upward, making it easy to replace or repair the CMU 5. Moreover, since a wire or the like connected from the CMU 5 to the BMS 9 is unnecessary, space utilization inside the battery case 27 is improved and the weight of the battery pack may be reduced.

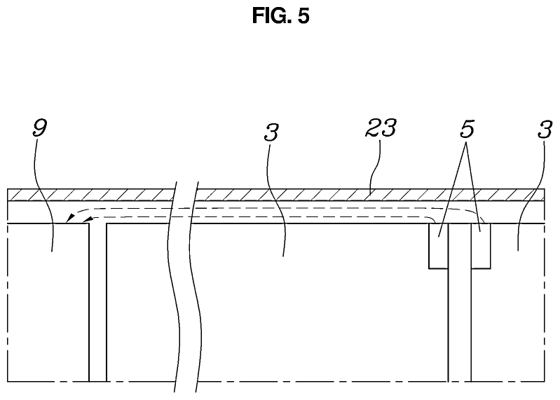

For reference, FIG. 5 is a view showing communication between the CMU 5 and the BMS 9 through a space between an upper cover 23 of the battery case 27 and the battery module 3.

In addition, as shown in FIG. 1, the battery case 27 may be configured to include a lower case 25 accommodating a plurality of battery module assemblies 7 and the upper cover 23. The upper cover 23 is coupled to the upper side of the lower case 25 to block the battery module assemblies 7 inside the battery case 27 from the outside.

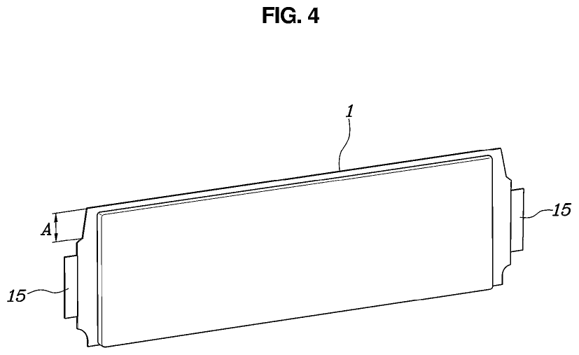

In addition, FIG. 4 shows one of the battery cells 1 constituting the battery module 3. Ultimately, an area A indicated at the upper corner of the battery cell 1 in FIG. 4 is used as the installation space for the PCB 13 and the CMU 5 as described herein.

A battery pack for vehicles according to the present disclosure includes a battery module assembly 7 including a battery module 3 formed by overlapping battery cells 1 and a CMU 5. The CMU 5 is coupled to one side of the battery module 3 to acquire information on the battery cells 1 constituting the battery module 3. Furthermore, the CMU 5 is configured to wirelessly transmit the acquired information on each of the battery cells 1 to a BMS 9. The battery pack further includes a battery case 27 provided to accommodate a plurality of the battery module assemblies 7 and the BMS 9. The BMS 9 is provided in the battery case 27 to receive the acquired information on each of the battery cells 1 transmitted from respective CMUs 5 of the plurality of battery module assemblies 7.

The plurality of battery module assemblies 7 are disposed in a single layer in the battery case 27. The CMU 5 of each of the battery module assemblies 7 is coupled to the upper corner of the respective battery module 3. The CMU 5 of the battery module assembly 7 and the BMS 9 may communicate through a space formed between the upper side of the battery module 3 and an upper cover 23 of the battery case 27.

Of course, the CMU 5 may be configured to be coupled to the battery module 3 by moving downward in a straight line with respect to the battery module 3. Furthermore, the CMU 5 may be configured to be separated from the battery module 3 by moving upward with respect to the battery module 3.

The battery module 3 is provided with a PCB 13 electrically connected to the battery cells 1 constituting the battery module 3. The connector 11 is provided on the PCB 13.

Cell electrodes 15 are provided on at least one side of the battery cells 1 constituting the battery module 3. The cell electrodes 15 are respectively connected to bus bars 19 provided in a sensing block 17. The PCB 13 is mounted on the sensing block 17 to be connected to the bus bars 19.

Although the present disclosure has been shown and described with respect to specific embodiments, it should be apparent to those having ordinary skill in the art that the present disclosure may be variously improved and changed without departing from the technical spirit of the present disclosure provided by the following claims.

What is claimed is:

1. A battery module assembly structure for vehicles, the battery module assembly structure comprising:
a battery module formed by overlapping battery cells; and
a cell management unit (CMU) coupled to a side of the battery module to acquire information on the battery cells constituting the battery module.

2. The battery module assembly structure of claim 1, wherein the CMU is configured to move linearly with respect to the battery module and be coupled to a corner of the battery module.

3. The battery module assembly structure of claim 2, wherein the CMU is configured to be coupled to the battery module by moving downward with respect to the battery module and is configured to be separated from the battery module by moving upward with respect to the battery module.

4. The battery module assembly structure of claim 2, wherein the battery module and the CMU are provided with respective connectors capable of mutual engagement so that the battery module and the CMU are electrically connected with each other by linear displacement of the CMU with respect to the battery module.

5. The battery module assembly structure of claim 4, wherein the battery module is provided with a printed circuit board (PCB) electrically connected to the battery cells constituting the battery module, and wherein the connector of the battery module is provided on the PCB.

6. The battery module assembly structure for vehicles of claim 5, wherein
cell electrodes are provided at least on one side of the battery cells constituting the battery module,
the cell electrodes are respectively connected to bus bars provided in a sensing block, and
the PCB is mounted on the sensing block so as to be connected to the bus bars.

7. The battery module assembly structure of claim 2, wherein the CMU is coupled to an upper corner of the battery module and is configured to wirelessly transmit information on each battery cell of the battery cells constituting the battery module to a battery management system (BMS).

8. A battery pack for vehicles, the battery pack comprising:
a plurality of battery module assemblies each including a battery module formed by overlapping battery cells;
a cell management unit (CMU) coupled to a side of each respective battery module to acquire information on the battery cells constituting the respective battery module and configured to wirelessly transmit the acquired information on each of the battery cells to a battery management system (BMS); and
a battery case provided to accommodate the plurality of battery module assemblies,
wherein the BMS is provided in the battery case to receive the acquired information on each of the battery cells transmitted from respective CMUs of the plurality of battery module assemblies.

9. The battery pack of claim 8, wherein
the plurality of battery module assemblies is disposed in a single layer in the battery case,
the CMU of each of the plurality of battery module assemblies is coupled to an upper corner of the respective battery module, and
the CMU of each of the plurality battery module assemblies and the BMS communicate through a space formed between an upper side of each of the respective battery modules and an upper cover of the battery case.

10. The battery pack of claim 9, wherein each CMU is configured to be coupled to the respective battery module by moving downward with respect to the battery module and is configured to be separated from the battery module by moving upward with respect to the battery module.

11. The battery pack of claim 10, wherein each CMU and the respective battery module are provided with respective connectors capable of mutual engagement, so that the respective battery module and the CMU are electrically connected with each other by linear displacement of the CMU with respect to the respective battery module.

12. The battery pack of claim 11, wherein each battery module is provided with a printed circuit board (PCB) electrically connected to the battery cells constituting the battery module, and wherein the connector of the battery module is provided on the PCB.

13. The battery pack of claim 12, wherein
cell electrodes are provided at least on one side of the battery cells constituting each battery module,
the cell electrodes are respectively connected to bus bars provided in a sensing block, and
the PCB is mounted on the sensing block so as to be connected to the bus bars.
